(19) United States
(12) Patent Application Publication
(10) Pub. No.: US 2015/0286309 A1
(43) Pub. Date: Oct. 8, 2015

(54) PASSIVE TOUCH PEN

(71) Applicant: Primax Electronics Ltd., Taipei (TW)

(72) Inventors: A-MING CHANG, Taipei (TW); Chien-Pang Chien, Taipei (TW); Ying-Che Tseng, Taipei (TW)

(21) Appl. No.: 14/297,365

(22) Filed: Jun. 5, 2014

(30) Foreign Application Priority Data
Apr. 3, 2014 (CN) 201420161416.7

(51) Int. Cl. G06F 3/044; G06F 3/0354

(52) U.S. Cl. CPC G06F 3/044; G06F 3/03545

(57) ABSTRACT

A passive touch pen for a capacitive touch screen is provided. The passive touch pen includes a conductive pen tube, a solid fixing post, and a conductive pen tip. The solid fixing post is disposed within the conductive pen tube. The conductive pen tip is sheathed around the solid fixing post and exposed outside the conductive pen tube. The conductive pen tip includes a protrusion part. The protrusion part is protruded from an inner surface of the conductive pen tip and contacted with the solid fixing post. After the conductive pen tip is compressed in the direction toward the solid fixing post, the conductive pen tip is restored to a non-compressed original shape in response to a restoring force of the protrusion part. Since the conductive pen tip has the elastic protrusion part, it is not necessary to form a vent in the solid fixing post.

### FIELD OF THE INVENTION

The present invention relates to a touch pen, and more particularly to a passive touch pen for a capacitive touch screen.

### BACKGROUND OF THE INVENTION

Nowadays, the commercially available touch screens are classified into several types, including a resistive touch screen, an acoustic wave touch screen, an infrared touch screen and a capacitive touch screen. When an external force is exerted on the resistive touch screen, a voltage is generated and a command is recognized according to the voltage. Moreover, acoustic waves or infrared rays pass over the surface of the acoustic wave touch screen or the infrared touch screen. By touching the surface of the acoustic wave touch screen or the infrared touch screen, the travelling path of the acoustic wave or the infrared ray is blocked and thus the corresponding command is recognized. When the human body is contacted with the capacitive touch screen, the capacitance value of the touch point of the touch screen is subjected to a change. According to the change of the capacitance value, the touch position is recognized. In views of the touch accuracy and the fabricating cost, the capacitive touch screen is widely adopted.

For complying with the utilized function of the capacitive touch screen, a capacitive touch pen is introduced into the market. Generally, the capacitive touch pen is used for tapping or selecting the capacitive touch screen. In addition, the capacitive touch pen may also have the handwriting and drawing functions. In accordance with the current technology, the capacitive touch pens are classified into two types, i.e. active touch pens and passive touch pens. The passive touch pen has a contact tip made of a conductive rubber. Moreover, the conductive rubber tip is combined with a metallic pen tube. When the conductive rubber tip touches the capacitive touch screen, the electric energy of the human body is transmitted to the conductive rubber tip through the metallic pen tube. Consequently, the capacitance value of the touch point between the capacitive touch screen and the conductive rubber tip is subjected to a change.

Hereinafter, the structure of a conventional passive touch pen will be illustrated with reference to FIGS. 1˜3. FIG. 1 is a schematic perspective view illustrating the outer appearance of a conventional passive touch pen. FIG. 2 is a schematic exploded view illustrating the conventional passive touch pen. FIG. 3 is a schematic cross-sectional view illustrating the conventional passive touch pen. The conventional passive touch pen 1 comprises a hollow metallic pen tube 11 and a sensing pen tip set 12. The sensing pen tip set 12 is fixed on a front end 111 of the pen tube 11. The pen tube 11 may be grasped by the user's hand. When the sensing pen tip set 12 at the front end 111 of the pen tube 11 touches the touch screen, a pointing effect (not shown) on the touch screen is correspondingly controlled.

The sensing pen tip set 12 at least comprises a conductive rubber tip 121 and a fixing post 122. The conductive rubber tip 121 may touch a surface of the touch screen (not shown). The fixing post 122 is used to fix the conductive rubber tip 121.

Please refer to FIG. 3. The conductive rubber tip 121 is sheathed around the fixing post 122. Moreover, there is a vacant space 13 between the conductive rubber tip 121 and the fixing post 122. When the touch screen is pressed by the conductive rubber tip 121 and the conductive rubber tip 121 is compressed in the direction toward the fixing post 122, the air within the vacant space 13 is discharged to the outside of the vacant space 13 through a vent 1221. When the conductive rubber tip 121 is no longer compressed, the air is introduced into the vacant space 13 through the vent 1221. Consequently, the conductive rubber tip 121 is restored to its original shape where the conductive rubber tip 121 is not compressed.

However, the conventional passive touch pen 1 still has some drawbacks. For example, the arrangement of the vent 1221 may increase the complexity of the fabricating process and increase the fabricating cost. It is important to provide a passive touch pen without the vent 1221. Even if there is no vent, the conductive rubber tip 121 has to be automatically restored to the non-compressed original shape when the conductive rubber tip 121 is no longer compressed.

### SUMMARY OF THE INVENTION

An object of the present invention provides a passive touch pen having a function of restoring a conductive pen tip to the non-compressed original shape in response to its own restoring force. Consequently, the complexity of the fabricating process and the fabricating cost are reduced.

In accordance with an aspect of the present invention, there is provided a passive touch pen for a capacitive touch screen. The passive touch pen includes a conductive pen tube, a solid fixing post, and a conductive pen tip. The solid fixing post is made of a conductive material, and disposed within the conductive pen tube. The conductive pen tip is connected with the solid fixing post and exposed outside the conductive pen tube. The conductive pen tip includes a protrusion part. The protrusion part is protruded from an inner surface of the conductive pen tip and contacted with the solid fixing post. After the conductive pen tip is compressed, the conductive pen tip is restored to an original shape by the protrusion part.

In accordance with another aspect of the present invention, there is provided a passive touch pen for a capacitive touch screen. The passive touch pen includes a first pen tube, a second pen tube, a solid fixing post, a conductive plate, an a conductive pen tip. The first pen tube is made of a conductive material. The second pen tube is made of a nonconductive material. A rear end of the second pen tube is connected with the first pen tube. The solid fixing post is made of a conductive material, and disposed within the second pen tube. The conductive plate is disposed within the second pen tube. A first end of the conductive plate is contacted with the first pen tube, and a second end of the conductive plate is located near the solid fixing post. The conductive pen tip is connected with the solid fixing post and exposed outside a front end of the second pen tube. The conductive pen tip includes a protrusion part. The protrusion part is protruded from an inner surface of the conductive pen tip and contacted with the solid fixing post. After the conductive pen tip is compressed, the conductive pen tip is restored to an original shape by the protrusion part.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outer appearance of a conventional passive touch pen;

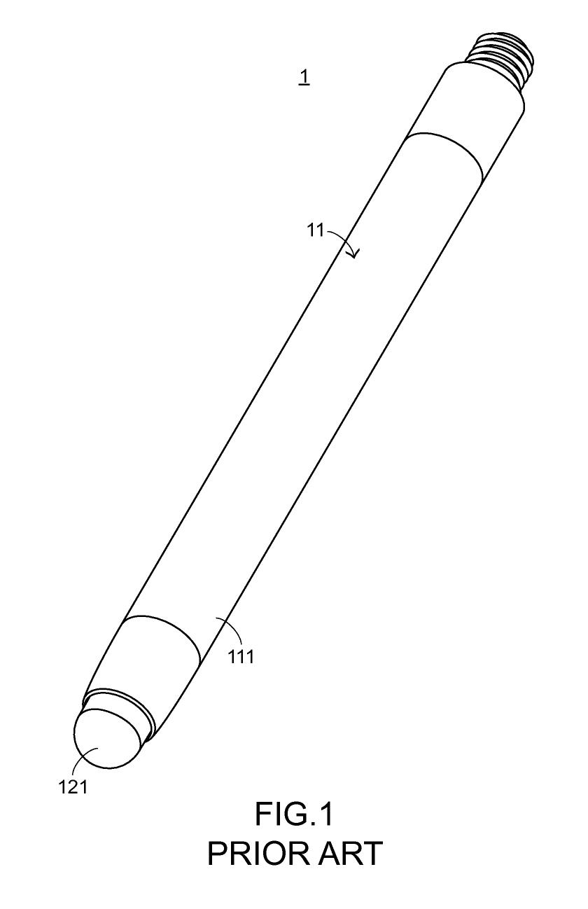

FIG. 2 is a schematic exploded view illustrating the conventional passive touch pen;

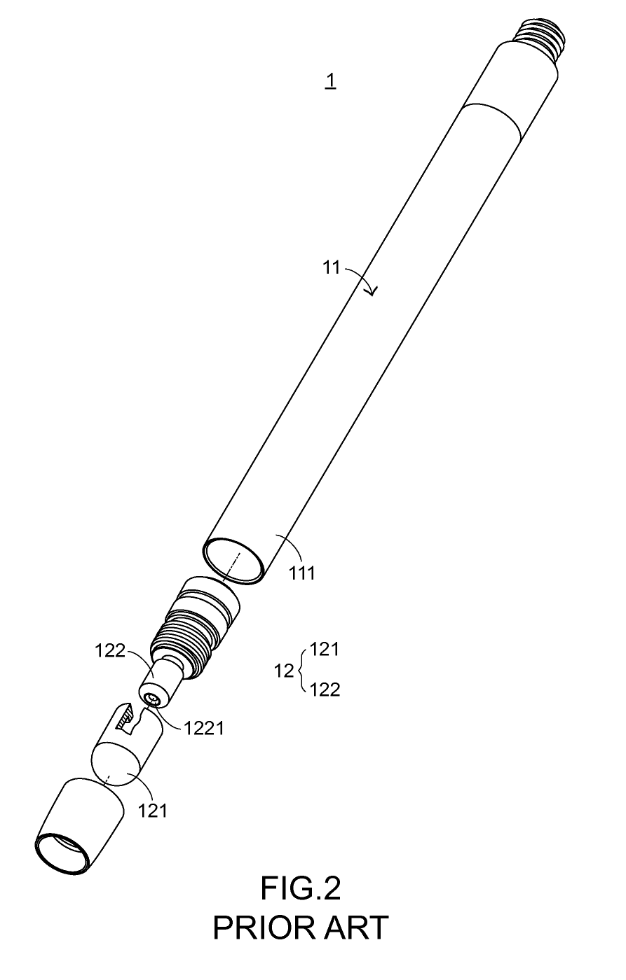

FIG. 3 is a schematic cross-sectional view illustrating the conventional passive touch pen;

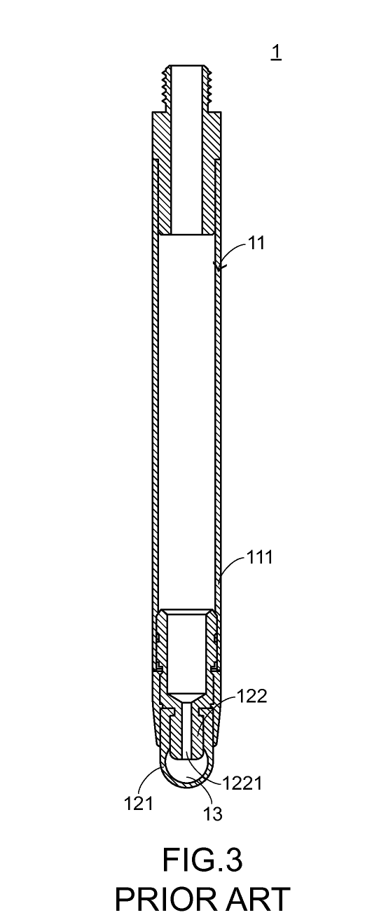

FIG. 4 is a schematic perspective view illustrating the outer appearance of a passive touch pen according to a first embodiment of the present invention;

FIG. 5 is a schematic exploded view illustrating the passive touch pen according to the first embodiment of the present invention;

FIG. 6 is a schematic cutaway view illustrating a solid fixing post and the conductive pen tip of the passive touch pen of FIG. 5;

FIG. 7 is a schematic cutaway view illustrating the conductive pen tip of the passive touch pen according to the first embodiment of the present invention;

FIG. 8 is a schematic exploded view illustrating a passive touch pen according to a second embodiment of the present invention;

FIG. 9 is a schematic exploded view illustrating a passive touch pen according to a third embodiment of the present invention; and

FIG. 10 is a schematic exploded view illustrating a passive touch pen according to a fourth embodiment of the present invention.

### DETAILED DESCRIPTION OF THE PREFERRED EMBODIMENT

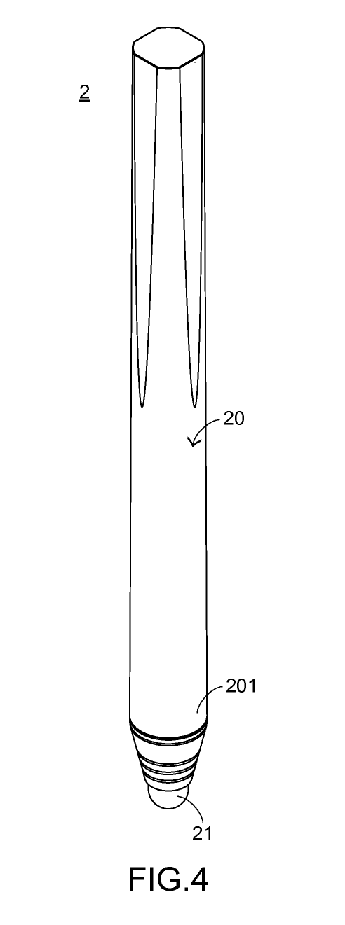

Hereinafter, a passive touch pen 2 according to a first embodiment of the present invention will be illustrated with reference to FIG. 4. FIG. 4 is a schematic perspective view illustrating the outer appearance of a passive touch pen according to a first embodiment of the present invention.

As shown in FIG. 4, the passive touch pen 2 of this embodiment comprises a conductive pen tube 20 and a conductive pen tip 21. The conductive pen tip 21 is located at a front end 201 of the conductive pen tube 20. By grasping the conductive pen tube 20, the user may operate the conductive pen tip 21 to control a capacitive touch screen (not shown), which will be illustrated as follows.

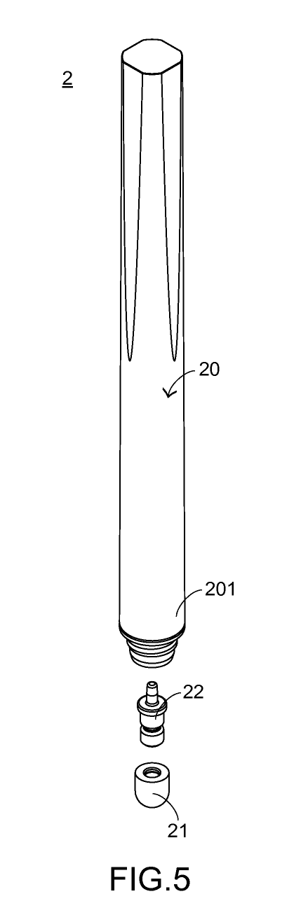

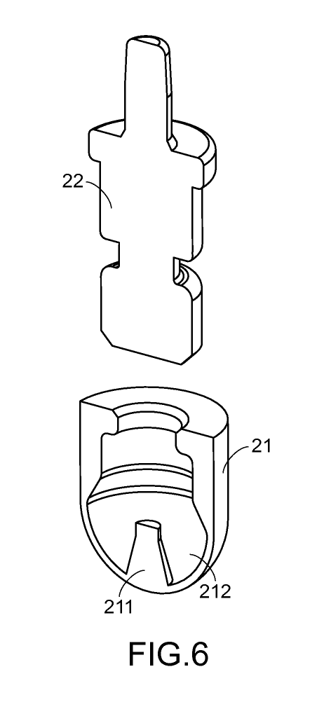

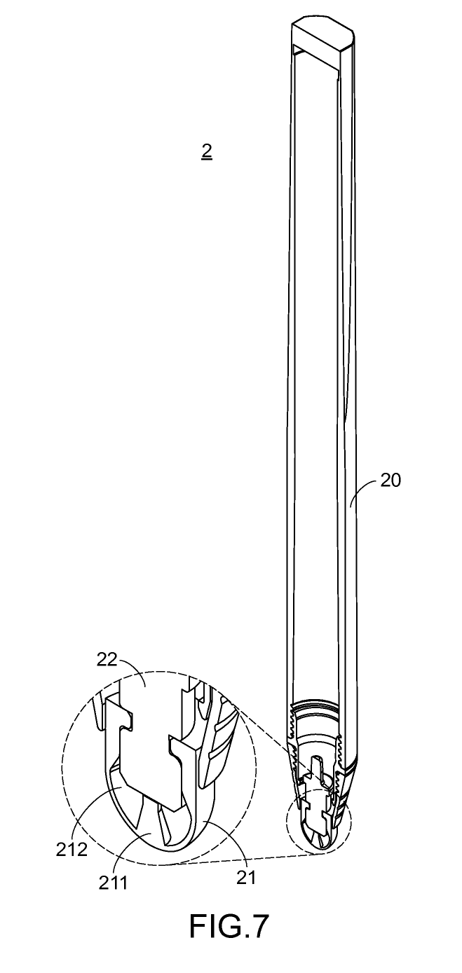

Hereinafter, the components of the passive touch pen 2 and the assembling sequence thereof will be illustrated with reference to FIGS. 5˜7. FIG. 5 is a schematic exploded view illustrating the passive touch pen according to the first embodiment of the present invention. FIG. 6 is a schematic cutaway view illustrating a solid fixing post and the conductive pen tip of the passive touch pen of FIG. 5. FIG. 7 is a schematic cutaway view illustrating the conductive pen tip of the passive touch pen according to the first embodiment of the present invention.

As shown in FIG. 5, the passive touch pen 2 comprises the conductive pen tube 20, the conductive pen tip 21, and a solid fixing post 22. In this embodiment, the conductive pen tube 20 is made of a metallic material, the solid fixing post 22 is made of a metallic material or a conductive plastic material, and the conductive pen tip 21 is made of a conductive rubbery material. It is noted that the materials of these components are not restricted.

Please refer to FIG. 5 and FIG. 7. For assembling the passive touch pen 2, the solid fixing post 22 is disposed within the conductive pen tube 20 and contacted with the conductive pen tube 20, and the conductive pen tip 21 is sheathed around the solid fixing post 22 and exposed outside the front end 201 of the conductive pen tube 20.

Moreover, the conductive pen tip 21 comprises a protrusion part 211. The protrusion part 211 is protruded from an inner surface 212 of the conductive pen tip 21. After the conductive pen tip 21 is sheathed around the solid fixing post 22, the protrusion part 211 is contacted with the solid fixing post 22 (see FIGS. 6 and 7). As long as the protrusion part 211 is contacted with the solid fixing post 22 after the conductive pen tip 21 is sheathed around the solid fixing post 22, the shape of the protrusion part 211 and the protruded position of the protrusion part 211 on the inner surface 212 of the conductive pen tip 21 are not restricted.

After the above assembling process is completed, the user may grasp the conductive pen tube 20 and press the capacitive touch screen (not shown) with the conductive pen tip 21. Under this circumstance, the electric energy of the human body is transmitted to the conductive pen tip 21 through the conductive pen tube 20 and the solid fixing post 22. Consequently, a coupling capacitance between the conductive pen tip 21 and the capacitive touch screen is generated. According to the coupling capacitance, a position of the touch point between the conductive pen tip 21 and the capacitive touch screen may be calculated by a controller (not shown) of the capacitive touch screen.

When the touch screen is pressed by the conductive pen tip 21 and the conductive pen tip 21 is compressed in the direction toward the solid fixing post 22, the protrusion part 211 is in a compressed state. On the other hand, when the touch screen is no longer pressed by the conductive pen tip 21, the conductive pen tip 21 is restored to the non-compressed original shape in response to the restoring force of the protrusion part 211. From the above descriptions, the solid fixing post 22 of the passive touch pen 2 of this embodiment is not equipped with the vent 1221 of the fixing post 122 of the conventional passive touch pen 1.

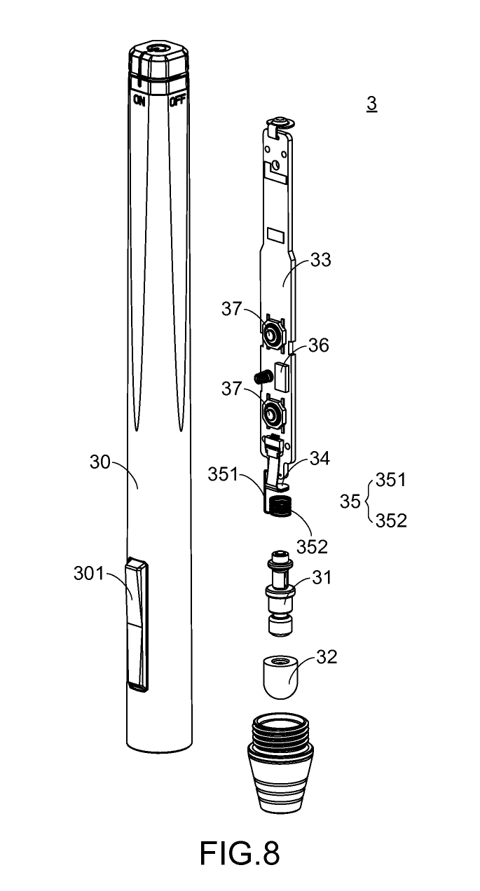

Hereinafter, a passive touch pen 3 according to a second embodiment of the present invention will be illustrated with reference to FIG. 8. FIG. 8 is a schematic exploded view illustrating a passive touch pen according to a second embodiment of the present invention.

As shown in FIG. 8, the passive touch pen 3 comprises a conductive pen tube 30, a solid fixing post 31, a conductive pen tip 32, a circuit board 33, a pressure sensor 34, a conductive elastic element 35, and a wireless transmission module 36. In this embodiment, the conductive pen tube 30 is made of a metallic material, the solid fixing post 31 is made of a metallic material or a conductive plastic material, and the conductive pen tip 32 is made of a conductive rubbery material. It is noted that the materials of these components are not restricted. Moreover, an example of the wireless transmission module 36 includes but is not limited to a Bluetooth transmission module.

In comparison with the first embodiment, the passive touch pen 3 of this embodiment at least provides a function of sensing a pen pressure. The function of sensing the pen pressure will be illustrated as follows. Firstly, the circuit board 33 is disposed within the conductive pen tube 30, and the pressure sensor 34 and an end 351 of the conductive elastic element 35 are connected with a bottom edge of the circuit board 33. Then, the solid fixing post 31 is disposed under the circuit board 33 and contacted with the pressure sensor 34. Moreover, a helical part 352 of the conductive elastic element 35 is sheathed around the solid fixing post 31, and the conductive pen tip 32 is sheathed around the solid fixing post 31 and exposed outside the conductive pen tube 30. The structures and the operating principles of the conductive pen tip 32 and the solid fixing post 31 of this embodiment are similar to those of the first embodiment, and are not redundantly described herein.

Moreover, the conductive pen tube 30 further comprises an insulation zone 301. The wireless transmission module 36 is disposed on the circuit board 33 and aligned with the insulation zone 301. Consequently, the interference affecting the wireless transmission module 36 will be minimized. In this embodiment, the insulation zone 301 is a plastic element corresponding to a push switch 37 on the circuit board 33.

Under this circumstance, the insulation zone 301 is movable relative to the conductive pen tube 30. Alternatively, in some other embodiments, the insulation zone 301 is not movable relative to the conductive pen tube 30. Under this circumstance, the push switch 37 is not disposed on the circuit board 33.

When a capacitive touch screen (not shown) is pressed by the conductive pen tip 32, the conductive pen tip 32 is compressed to push the solid fixing post 31. Consequently, the solid fixing post 31 is moved toward the pressure sensor 34. In this embodiment, the pressure sensor 34 is a piezoelectric pressure sensor. When the force pressing the pressure sensor 34 is increased, the resistance value of the pressure sensor 34 is decreased. By reading the change of the resistance value, a controller (not shown) may judge the compressed force that is exerted on the pressure sensor 34.

Then, the compressed force exerted on the pressure sensor 34 is transmitted from the controller to the wireless transmission module 36. According to the compressed force exerted on the pressure sensor 34, a corresponding signal is transmitted from the wireless transmission module 36 to the capacitive touch screen. According to the signal, a thicker line or a thinner line corresponding to the applied force of the user will be shown on the capacitive touch screen. Consequently, the function of sensing the pen pressure is achieved.

Moreover, in case that the applied force of the user is decreased, the acting force between the conductive elastic element 35 and the solid fixing post 31 will return the solid fixing post 31 to the original position. Under this circumstance, the compressed force exerted on the pressure sensor 34 is decreased.

It is noted that the pressure sensor 34 used in some other embodiments is not restricted to the piezoelectric pressure sensor. Another example of the pressure sensor 34 includes but is not limited to a capacitive pressure sensor or an optical pressure sensor.

The remaining configuration, the assembling process and the operating principle of the passive touch pen 3 of this embodiment are identical to those of the passive touch pen 2 of the first embodiment, and are not redundantly described herein.

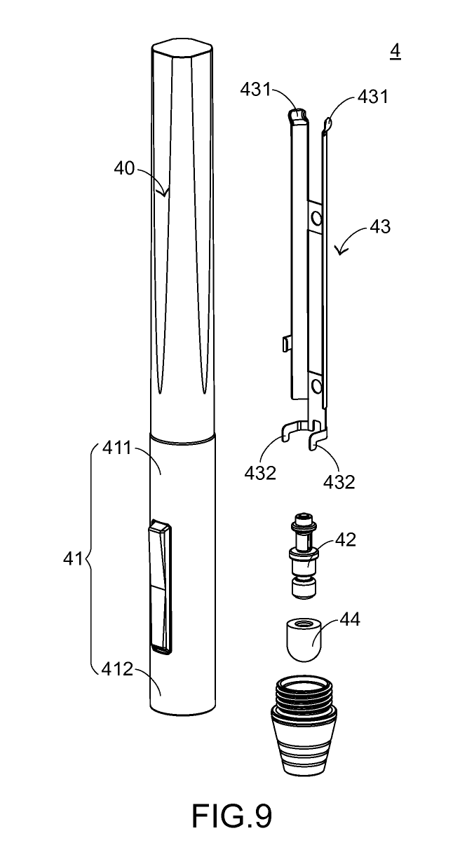

Hereinafter, a passive touch pen 4 according to a third embodiment of the present invention will be illustrated with reference to FIG. 9. FIG. 9 is a schematic exploded view illustrating a passive touch pen according to a third embodiment of the present invention.

As shown in FIG. 9, the passive touch pen 4 comprises a first pen tube 40, a second pen tube 41, a solid fixing post 42, a conductive plate 43, and a conductive pen tip 44. In this embodiment, the first pen tube 40 is made of a conductive material (e.g. a metallic material), the second pen tube 41 is made of a nonconductive material (e.g. a plastic material), the solid fixing post 42 is made of a metallic material or a conductive plastic material, the conductive plate 43 is made of a metallic material, and the conductive pen tip 44 is made of a conductive rubbery material. It is noted that the materials of these components are not restricted.

For assembling the passive touch pen 4, a rear end 411 of the second pen tube 41 is connected with the first pen tube 40. The solid fixing post 42 is disposed within the second pen tube 41. The conductive pen tip 44 is sheathed around the solid fixing post 42 and exposed outside a front end 412 of the second pen tube 41. The structures and the operating principles of the conductive pen tip 44 and the solid fixing post 42 of this embodiment are similar to those of the first embodiment, and are not redundantly described herein.

The conductive plate 43 is disposed within the second pen tube 41. A first end 431 of the conductive plate 43 is contacted with the first pen tube 40. A second end 432 of the conductive plate 43 is located near the solid fixing post 42.

As mentioned above, the passive touch pen 2 of the first embodiment comprises a single conductive pen tube 20. In contrast, the passive touch pen 4 of this embodiment comprises the first pen tube 40 and the second pen tube 41. Moreover, the second pen tube 41 is made of the nonconductive material. Since the second pen tube 41 is made of the nonconductive material, when the first pen tube 40 or the second pen tube 41 is grasped by the user and a capacitive touch screen (not shown) is pressed by the conductive pen tip 44, the electric energy of the human body fails to be transmitted to the conductive rubber tip 44 through the first pen tube 40 or the second pen tube 41. In this embodiment, the passive touch pen 4 further comprises the conductive plate 43. Consequently, the electric energy of the human body is transmitted to the conductive rubber tip 44 through the first pen tube 40, the conductive plate 43 and the solid fixing post 42. Alternatively, due to a coupling effect between the human body and the conductive plate 43, the electric energy of the human body is transmitted to the conductive rubber tip 44 through the conductive plate 43 and the solid fixing post 42.

The remaining configuration, the assembling process and the operating principle of the passive touch pen 4 of this embodiment are identical to those of the passive touch pen 2 of the first embodiment, and are not redundantly described herein.

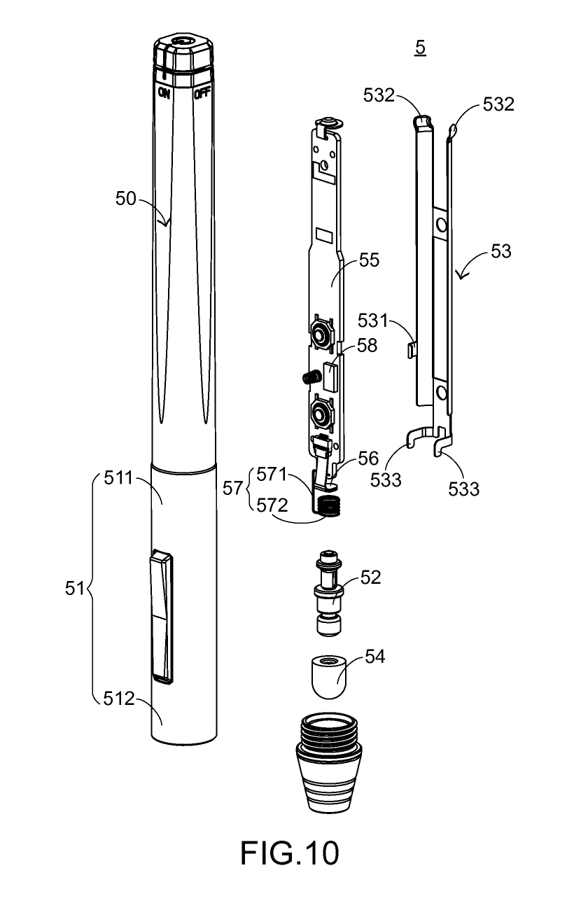

Hereinafter, a passive touch pen 5 according to a fourth embodiment of the present invention will be illustrated with reference to FIG. 10. FIG. 10 is a schematic exploded view illustrating a passive touch pen according to a fourth embodiment of the present invention.

As shown in FIG. 10, the passive touch pen 5 comprises a first pen tube 50, a second pen tube 51, a solid fixing post 52, a conductive plate 53, a conductive pen tip 54, a circuit board 55, a pressure sensor 56, a conductive elastic element 57, and a wireless transmission module 58. In this embodiment, the first pen tube 50 is made of a conductive material (e.g. a metallic material), the second pen tube 51 is made of a nonconductive material (e.g. a plastic material), the solid fixing post 52 is made of a metallic material or a conductive plastic material, the conductive plate 53 is made of a metallic material, and the conductive pen tip 54 is made of a conductive rubbery material. It is noted that the materials of these components are not restricted. Moreover, an example of the wireless transmission module 58 includes but is not limited to a Bluetooth transmission module.

For assembling the passive touch pen 5, a rear end 511 of the second pen tube 51 is connected with the first pen tube 50. The circuit board 55 is disposed within the second pen tube 51, and the pressure sensor 56 and an end 571 of the conductive elastic element 57 are connected with a bottom edge of the circuit board 55.

Then, a middle region 531 of the conductive plate 53 is connected with the circuit board 55. A first end 532 of the conductive plate 53 is contacted with the first pen tube 50. A second end 533 of the conductive plate 53 is located near a front end 512 of the second pen tube 51.

Moreover, the solid fixing post 52 is disposed under the circuit board 55 and contacted with the pressure sensor 56. Moreover, a helical part 572 of the conductive elastic element 57 is sheathed around the solid fixing post 52, and the conductive pen tip 54 is sheathed around the solid fixing post 52 and exposed outside the front end 512 of the second pen tube 51. The structures and the operating principles of the conductive pen tip 54 and the solid fixing post 52 of this embodiment are similar to those of the first embodiment, and are not redundantly described herein.

As mentioned above, the passive touch pen 3 of the second embodiment comprises a single conductive pen tube 30. In contrast, the passive touch pen 5 of this embodiment comprises the first pen tube 50 and the second pen tube 51. Moreover, the second pen tube 51 is made of the nonconductive material. Since the second pen tube 51 is made of the nonconductive material, when the first pen tube 50 or the second pen tube 51 is grasped by the user and a capacitive touch screen (not shown) is pressed by the conductive pen tip 54, the electric energy of the human body fails to be transmitted to the conductive rubber tip 54 through the first pen tube 50 or the second pen tube 51. In this embodiment, the passive touch pen 5 further comprises the conductive plate 53. Consequently, the electric energy of the human body is transmitted to the conductive rubber tip 54 through the first pen tube 50, the conductive plate 53, the circuit board 55, the conductive elastic element 57 and the solid fixing post 52. Alternatively, due to a coupling effect between the human body and the conductive plate 53, the electric energy of the human body is transmitted to the conductive rubber tip 54 through the conductive plate 53, the circuit board 55, the conductive elastic element 57 and the solid fixing post 52.

The remaining configuration, the assembling process and the operating principle of the passive touch pen 5 of this embodiment are identical to those of the passive touch pen 3 of the second embodiment, and are not redundantly described herein.

From the above descriptions, the conductive pen tip of the passive touch pen of the present invention comprises the protrusion part. The protrusion part is protruded from the inner surface of the conductive pen tip. After the conductive pen tip is compressed in the direction toward the solid fixing post, the conductive pen tip may be restored to the non-compressed original shape in response to the restoring force of the protrusion part. That is, it is not necessary to form a vent in the solid fixing post of the passive touch pen of the present invention. Under this circumstance, the complexity of the fabricating process and the fabricating cost are both reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A passive touch pen for a capacitive touch screen, the passive touch pen comprising:
a conductive pen tube;
a solid fixing post made of a conductive material, and disposed within the conductive pen tube; and
a conductive pen tip connected with the solid fixing post and exposed outside the conductive pen tube, wherein the conductive pen tip comprises a protrusion part, and the protrusion part is protruded from an inner surface of the conductive pen tip and contacted with the solid fixing post, wherein after the conductive pen tip is compressed, the conductive pen tip is restored to an original shape by the protrusion part.

2. The passive touch pen according to claim 1, wherein the solid fixing post is contacted with the conductive pen tip.

3. The passive touch pen according to claim 1, wherein the conductive pen tube comprises an insulation zone, and the passive touch pen further comprises:
a circuit board disposed within the conductive pen tube;
a pressure sensor connected with the circuit board and located beside the solid fixing post, wherein when the pressure sensor is pressed by the solid fixing post, a compressed force exerted on the conductive pen tip is sensed by the pressure sensor;
a conductive elastic element connected with the circuit board and sheathed around the solid fixing post, wherein the solid fixing post is returned to an original position by the conductive elastic element; and
a wireless transmission module disposed on the circuit board and aligned with the insulation zone, wherein according to the compressed force exerted on the conductive pen tip, the wireless transmission module issues a corresponding signal to the capacitive touch screen.

4. The passive touch pen according to claim 3, wherein the wireless transmission module is a Bluetooth transmission module.

5. The passive touch pen according to claim 1, wherein the conductive pen tube is made of a metallic material, the solid fixing post is made of a metallic material or a conductive plastic material, and the conductive pen tip is made of a conductive rubbery material.

6. A passive touch pen for a capacitive touch screen, the passive touch pen comprising:
a first pen tube made of a conductive material;
a second pen tube made of a nonconductive material, wherein a rear end of the second pen tube is connected with the first pen tube;
a solid fixing post made of a conductive material, and disposed within the second pen tube;
a conductive plate disposed within the second pen tube, wherein a first end of the conductive plate is contacted with the first pen tube, and a second end of the conductive plate is located near the solid fixing post; and
a conductive pen tip connected with the solid fixing post and exposed outside a front end of the second pen tube, wherein the conductive pen tip comprises a protrusion part, and the protrusion part is protruded from an inner surface of the conductive pen tip and contacted with the solid fixing post, wherein after the conductive pen tip is compressed, the conductive pen tip is restored to an original shape by the protrusion part.

7. The passive touch pen according to claim 6, wherein the passive touch pen further comprises:
a circuit board disposed within the second pen tube, wherein the conductive plate is connected with the circuit board;
a pressure sensor connected with the circuit board and located beside the solid fixing post, wherein when the pressure sensor is pressed by the solid fixing post, a compressed force exerted on the conductive pen tip is sensed by the pressure sensor;
a conductive elastic element connected with the circuit board and sheathed around the solid fixing post, wherein the solid fixing post is returned to an original position by the conductive elastic element; and
a wireless transmission module disposed on the circuit board, wherein according to the compressed force exerted on the conductive pen tip, the wireless transmission module issues a corresponding signal to the capacitive touch screen.

8. The passive touch pen according to claim 7, wherein the wireless transmission module is a Bluetooth transmission module.
